(19) United States
(12) Patent Application Publication
(10) Pub. No.: US 2024/0318360 A1
(43) Pub. Date: Sep. 26, 2024

(54) BICOMPONENT FIBERS WITH CURVATURE

(71) Applicant: Dow Global Technologies LLC, Midlan, MI (US)

(72) Inventors: Akanksha Garg, Pearland, TX (US); Yijan Lin, Pearland, TX (US); Lanhe Zhang, Lake Jackson, TX (US); Ronald Wevers, Terneuzen (NL)

(21) Appl. No.: 18/579,389

(22) PCT Filed: Aug. 18, 2022
(86) PCT No.: PCT/US2022/075172

§ 371 Date: Jan. 15, 2024

Related U.S. Application Data
(60) Provisional application No. 63/243,320, filed on Sep. 13, 2021.

(51) Int. Cl. D01F 8/06; D01D 5/22; D04H 3/005

(52) U.S. Cl. CPC D01F 8/06; D01D 5/22; D04H 3/005; D10B 2321/021; D10B 2321/022

(57) ABSTRACT

Provided are bicomponent fibers with curvature. The bicomponent fiber includes a first region and a second region. The first region includes a polypropylene blend and second region includes an ethylene/alpha-olefin interpolymer composition. The polypropylene blend includes a polypropylene homopolymer and a propylene-ethylene interpolymer, wherein the propylene-ethylene interpolymer has a density of from 0.860 to 0.880 g/cc and a melt flow rate of greater than 12 g/10 min. The ethylene/alpha-olefin interpolymer composition has a density of greater than 0.920 g/cc and a melt index (I2) of from 10 to 25 g/10 min. The bicomponent fiber can be used to form a nonwoven.

### TECHNICAL FIELD

Embodiments of the present disclosure generally relate to bicomponent fibers with curvature, and nonwovens comprising the fibers.

### INTRODUCTION

Bicomponent fibers are fibers made of at least two different polymer compositions that are extruded from the same spinneret with the compositions contained within the same filament or fiber. When the fiber leaves the spinneret, it consists of non-mixed components that are fused at the interface. The two polymer compositions can differ in their chemical and/or physical properties. Bicomponent fibers can be formed by conventional spinning techniques known in the art and can be used for forming a nonwoven. Nonwoven fabrics have numerous applications, such as filters, disposable materials in medical applications, and diaperstock. To assist in reducing nonwoven weight or obtaining other advantageous nonwoven properties, such as loft, bicomponent fibers having curvature are desirable. However, problems exist with obtaining bicomponent fibers with curvature, and there remains a demand for nonwovens with loft and fibers having enhanced curvature.

### SUMMARY

Embodiments of the present disclosure provide bicomponent fibers that can be used to form nonwovens and that provide in aspects surprisingly high curvature. Bicomponent fibers according to embodiments of the present disclosure each include a first region and a second region that contribute to a fiber with improved curvature. Specifically, bicomponent fibers according to embodiments of the present disclosure comprise a polypropylene blend and an ethylene/alpha-olefin interpolymer composition that can enhance curvature of the fibers when part of a fiber at specific weight ratios.

Disclosed herein is a bicomponent fiber. In one embodiment, the bicomponent fiber comprises a fiber centroid; a first region having a first centroid and a second region having a second centroid; the first region comprising a polypropylene blend comprising from 50 to 90 wt. % of a polypropylene homopolymer, based on the total weight of the polypropylene blend, and from 10 to 50 wt. % of a propylene-ethylene interpolymer, based on the total weight of the polypropylene blend, wherein the propylene-ethylene interpolymer has a density of from 0.860 to 0.880 g/cc and a melt flow rate of greater than 12 g/10 min; the second region comprising an ethylene/alpha-olefin interpolymer composition having a density of greater than 0.920 g/cc and a melt index (12) of from 10 to 25 g/10 min; wherein at least one of the first centroid and the second centroid is not the same as the fiber centroid; and wherein the weight ratio of the first region to the second region is from 55:45 to 90:10.

Also disclosed herein are nonwovens formed from the bicomponent fiber disclosed herein. For example, a nonwoven fabric can be formed from the bicomponent fiber disclosed herein. In one embodiment, the nonwoven fabric comprises a bicomponent fiber comprising a fiber centroid; a first region having a first centroid and a second region having a second centroid; the first region comprising a polypropylene blend comprising from 50 to 90 wt. % of a polypropylene homopolymer, based on the total weight of the polypropylene blend, and from 10 to 50 wt. % of a propylene-ethylene interpolymer, based on the total weight of the polypropylene blend, wherein the propylene-ethylene interpolymer has a density of from 0.860 to 0.880 g/cc and a melt flow rate of greater than 12 g/10 min; the second region comprising an ethylene/alpha-olefin interpolymer composition having a density of greater than 0.920 g/cc and a melt index (12) of from 10 to 25 g/10 min; wherein at least one of the first centroid and the second centroid is not the same as the fiber centroid; and wherein the weight ratio of the first region to the second region is from 55:45 to 90:10

Additional features and advantages of the embodiments will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing and the following description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a scanning electron micrograph (SEM) cross-section image of a bicomponent fiber having an eccentric core sheath configuration and centroid off-set.

### DETAILED DESCRIPTION

Aspects of the disclosed bicomponent fibers are described in more detail below. The bicomponent fibers having curvature can be used to form nonwovens, and such nonwovens can have a wide variety of applications, including, for example, wipes, face masks, tissues, bandages, and other medical and hygiene products. It is noted however, that this is merely an illustrative implementation of the embodiments disclosed herein. The embodiments are applicable to other technologies that are susceptible to similar problems as those discussed above.

As used herein, the terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

As used herein, the term “interpolymer” refers to polymers prepared by the polymerization of at least two different types of monomers. The term interpolymer thus includes copolymers (employed to refer to polymers prepared from two different types of monomers), and polymers prepared from more than two different types of monomers.

As used herein, the term “polymer” means a polymeric compound prepared by polymerizing monomers, whether of the same or a different type. The generic term polymer thus embraces the term homopolymer (employed to refer to polymers prepared from only one type of monomer, with the understanding that trace amounts of impurities can be incorporated into the polymer structure), and the term interpolymer. Trace amounts of impurities (for example, catalyst residues) may be incorporated into and/or within the polymer. A polymer may be a single polymer or polymer blend.

As used herein, the term “polyethylene” refers to a polymer comprising greater than 50% by weight of units which are derived from ethylene monomer, and optionally, one or more comonomers. A polyethylene includes polyethylene homopolymers, copolymers, or interpolymers. Common forms of polyethylene compositions known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE).

As used herein, the terms “nonwoven,” “nonwoven web,” and “nonwoven fabric” are used herein interchangeably. “Nonwoven” refers to a web or fabric having a structure of individual fibers or threads which are randomly interlaid, but not in an identifiable manner as is the case for a knitted fabric.

As used herein, the term “meltblown” refers to the fabrication of a nonwoven fabric via a process which includes the following steps: (a) extruding molten thermoplastic strands from a spinneret; (b) simultaneously quenching and attenuating the polymer stream immediately below the spinneret using streams of high velocity heated air; (c) collecting the drawn strands into a web on a collecting surface. Meltblown nonwoven webs can be bonded by a variety of means including, but not limited to, autogeneous bonding (i.e., self bonding without further treatment), thermo-calendaring process, adhesive bonding process, hot air bonding process, needle punch process, hydroentangling process, and combinations thereof.

As used herein, the term “spunbond” refers to the fabrication of a nonwoven fabric including the following steps: (a) extruding molten thermoplastic strands from a plurality of fine capillaries called a spinneret; (b) quenching the strands of the thermoplastic strands comprising, for example, a polyethylene composition, with a flow of air which is generally cooled in order to hasten the solidification of the molten strands of the thermoplastic; (c) attenuating the filaments by advancing them through the quench zone with a draw tension that can be applied by either pneumatically entraining the filaments in an air stream or by winding them around mechanical draw rolls of the type commonly used in the textile fibers industry; (d) collecting the drawn strands into a web on a foraminous surface (e.g., moving screen or porous belt); and (e) bonding the web of loose strands into the nonwoven fabric. Bonding can be achieved by a variety of means including, but not limited to, thermo-calendaring process, adhesive bonding process, hot air bonding process, needle punch process, hydroentangling process, and combinations thereof.

### Bicomponent Fibers

The fibers taught herein may be formed by any conventional spinning technique. For example, the first region and the second region of a bicomponent fiber can be formed into a fiber via melt spinning. In melt spinning, the first region and second region can be melted, coextruded, and forced through the fine orifices in a metallic plate, called a spinneret, into air or other gas, where they are cooled and solidified forming a bicomponent fiber. The solidified fiber may be drawn off via air jets, rotating rolls, or godets, and can be laid on a conveyer belt as a web for forming a nonwoven. A meltblown nonwoven comprising a bicomponent fiber according to embodiments of the present disclosure can be formed. In other embodiments, a spunbond nonwoven comprising a bicomponent fiber according to embodiments of the present disclosure can be formed.

The fibers disclosed herein have curvature.

In some embodiments, the bicomponent fiber has a curvature of at least 0.50 mm-1. The curvature of the bicomponent fiber can be measured in accordance with the test method described below. All individual values and subranges of at least 0.50 mm-1 are disclosed and included herein. For example, in some embodiments, the bicomponent fiber can have a curvature of at least 0.50, 0.60, 0.70, 0.80, 0.90, 1.00, 1.20, 1.40, 1.60, 1.80, 2.00, 2.20, 2.40, or 2.50 mm-1, when measured according to the test method described below. In other embodiments the bicomponent fiber can have a curvature in the range of from 0.50 to 4.50, from 1.00 to 4.50, from 1.50 to 4.50, from 2.00 to 4.50, from 2.50 to 4.50, from 3.00 to 4.50, from 1.00 to 4.20, from 1.50 to 4.20, from 2.00 to 4.20, or from 2.50 to 4.20 mm-1, when measured according to the test method described below.

In some embodiments, the bicomponent fiber comprises a first region and a second region, wherein the weight ratio of the first region to the second region is 55:45 to 90:10. All individual values and subranges of a ratio of from 55:45 to 90:10 are disclosed and included herein. For example, in embodiments, the weight ratio of the first region to the second region can be from 60:40 to 90:10, from 70:30 to 90:10, from 80:20 to 90:10, or from 55:45 to 80:20.

In some embodiments, the bicomponent fiber further comprises a third region comprising a polymer different from those in the first and second regions. In embodiments, the bicomponent fiber further comprises a third and a fourth region, where the third and fourth region comprises polymers different from those in the first and second regions.

### Centroids

In some embodiments, the bicomponent fiber comprises a fiber centroid and a first region having a first centroid and a second region having a second centroid, wherein at least one of the first centroid and the second centroid is not the same as the fiber centroid.

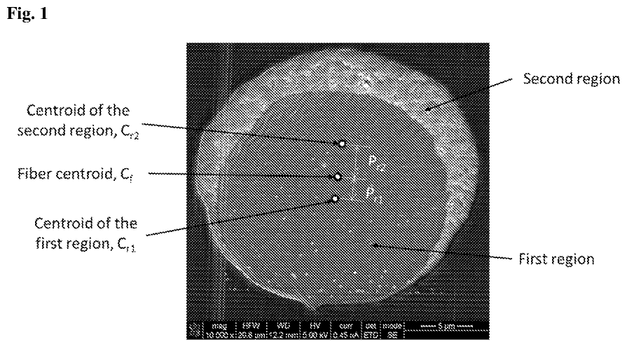

As used herein, the term “centroid” refers to the arithmetic mean of all the points of a region of a cross-section of a bicomponent fiber. For example, the bicomponent fiber according to embodiments of the present disclosure has a fiber centroid, which can be designated as C_{f}, and a region of the bicomponent fiber (e.g., the first or second region) has an independent centroid, which can be designated as Cᵣₓ, where x is a designation of the region (e.g., the first region can be designated as Cri and the second region can be designated as Cᵣ₂). FIG. 1 illustrates a bicomponent fiber and its centroid as well as the centroids of the first and second regions of the bicomponent fiber. The distance from a region centroid to the fiber centroid can be defined as “Pᵣₓ”, and the centroid offset of the first centroid or second centroid to the fiber centroid can be defined as “Pᵣₓ/r.”, where “r” is average radius of the fiber cross-section (average distance from C_{f} to the outer surface of the bicomponent fiber) and is calculated as \sqrt{A/π}, where A is the area of the bicomponent fiber cross-section.

In some embodiments, at least one of the first centroid and the second centroid is not the same as the fiber centroid. Where the first centroid or the second centroid are different than the fiber centroid, the bicomponent fiber can have different configurations, such as eccentric core sheath, side by side, or segmented pie, but cannot have a concentric configuration (e.g., a core sheath concentric configuration) where the fiber centroid, first centroid, and the second centroid are the same. In embodiments, the first centroid of the first region and the second centroid of the second region are arranged such that the first region and the second region are in a side by side configuration. In other embodiments, the first centroid of the first region and the second centroid of the second region are arranged such that the first region and the second region are in a segmented pie configuration. In further embodiments, the first centroid of the first region and the second centroid of the second region are arranged such that the first region and the second region are in an eccentric core-sheath configuration, where the first region is the core region and the second region is the sheath region of the bicomponent fiber and the sheath region surrounds the core region. In embodiments, the first and second regions are arranged in core sheath, side by side, segmented pie, or islands-in-the sea structures.

In some embodiments, the first centroid or the second centroid is offset from the fiber centroid by at least 0.1, or at least 0.2, or at least 0.4, and is less than 1 or less than 0.9, where offset is measured in accordance with the test method described below.

### First Region

The bicomponent fiber comprises a first region. The first region can be the core region in a core sheath configured bicomponent fiber. The first region has a first centroid. The first region comprises a polypropylene blend. In some embodiments, the polypropylene blend comprises a polypropylene homopolymer and a propylene-ethylene interpolymer. In some embodiments, the polypropylene blend of the first region comprises from 50 to 90 wt. % of a polypropylene homopolymer, based on the total weight of the polypropylene blend. All individual values of from 50 to 90 wt. % are disclosed and included herein. For example, the first region can comprise a polypropylene blend comprising from 55 to 90 wt. %, from 60 to 90 wt. %, from 65 to 90 wt. %, from 65 to 85 wt. %, from 65 to 80 wt. %, from 50 to 85 wt. %, from 50 to 80 wt. %, or from 50 to 75 wt. %, of a polypropylene homopolymer, based on total weight of the polypropylene blend.

In some embodiments, the polypropylene blend comprises from 10 to 50 wt. % of a propylene-ethylene interpolymer, based on total weight of the polypropylene blend. All individual values and subranges of from 10 to 50 wt. % are disclosed and included herein. For example, the polypropylene blend can comprise from 10 to 40 wt. %, from 10 to 35 wt. %, from 15 to 45 wt. %, from 15 to 50 wt. %, from 20 to 40 wt. %, from 25 to 50 wt. %, or from 25 to 35 wt. % of a propylene-ethylene interpolymer, based on total weight of the polypropylene blend. As used herein, the term “propylene-ethylene interpolymer” refers to an interpolymer comprising greater than 50% by weight of units of propylene monomer copolymerized with at least units derived from ethylene monomer.

In some embodiments, the propylene-ethylene interpolymer of the polypropylene blend has a density of from 0.860 to 0.880 g/cc. All individual values and subranges of from 0.860 to 0.880 g/cc are disclosed and included herein. For example, the propylene-ethylene interpolymer can have a density of from 0.860 to 0.878 g/cc, from 0.862 to 0.878 g/cc, from 0.864 to 0.878 g/cc, from 0.865 to 0.878 g/cc, from 0.867 to 0.876 g/cc, or from 0.867 to 0.874 g/cc, where density can be measured in accordance with ASTM D792.

In some embodiments, the propylene-ethylene interpolymer of the polypropylene blend has a melt flow rate of greater than 12 g/10 min, where melt flow rate is measured in accordance with ASTM D-1238 at 230° C. at 2.16 kg. All individual values and subranges of greater than 12 g/10 min are disclosed and included herein. For example, the propylene-ethylene interpolymer can have a melt flow rate greater than 14 g/10 min, greater than 16 g/10 min, greater than 18 g/10 min, greater than 20 g/10 min, greater than 22 g/10 min, or greater than 24 g/10 min, or can have a melt flow rate in the range of from 14 to 50 g/10 min, from 20 to 48 g/10 min, from 22 to 46 g/10 min, from 24 to 44 g/10 min, from 22 to 40 g/10 min, or from 24 to 40 g/10 min, where melt flow rate is measured in accordance with ASTM D-1238 at 230° C. at 2.16 kg.

At least 75%, at least 80%, at least 85%, at least 90%, at least 95%, at least 97%, at least 98%, at least 99%, or at least 100% (all percents being by weight based on total weight of the first region) of the first region of the fiber can be the polypropylene blend. The remainder of the first region may be additional components such as one or more other polymers and/or one or more additives. Other polymers could be another propylene-based polymer or polyethylene. The amount of the other polymer may be up to 25%. Potential additives include, but are not limited to, antistatic agents, color enhancers, dyes, lubricants, fillers such as TiO₂ or CaCO₃, opacifiers, nucleators, processing aids, pigments, primary antioxidants, secondary antioxidants, processing aids, UV stabilizers, anti-blocks, slip agents, tackifiers, fire retardants, anti-microbial agents, odor reducer agents, anti-fungal agents, and combinations thereof. The polypropylene blend may contain from about 0.01 or from about 0.1 or from about 1 to about 25 or to about 20 or to about 15 or to about 10 percent by the combined weight of such additives, based on the weight of the polypropylene blend including such additives.

### Second Region

The bicomponent fiber comprises a second region. The second region can be the sheath region of an eccentric core sheath configured bicomponent fiber. The second region has a second centroid. In some embodiments, the second region comprises an ethylene/alpha-olefin interpolymer composition. In some embodiments, the ethylene/alpha-olefin interpolymer composition has a density of greater than 0.920 g/cc and a melt index (12) of from 10 to 25 g/10 min.

As used herein, the term “ethylene/alpha-olefin interpolymer composition” refers to an interpolymer that comprises, in polymerized form, a majority amount of ethylene monomer (based on the weight of the interpolymer), and at least one alpha-olefin monomer. The ethylene/alpha-olefin interpolymer composition comprises (a) less than 100 percent, for example, at least 80 percent, or at least 90 percent, of the units derived from ethylene; and (b) less than 20 percent, for example, less than 15 percent, or less than 10 percent, by weight of units derived from one or more alpha-olefin comonomers. The alpha-olefin comonomers typically have no more than 20 carbon atoms. For example, the alpha-olefin comonomers may preferably have 3 to 10 carbon atoms, and more preferably 3 to 8 carbon atoms. Exemplary alpha-olefin comonomers include, but are not limited to, propylene, 1-butene, 1-pentene, 1-hexene, 1-heptene, 1-octene, 1-nonene, 1-decene, and 4-methyl-1-pentene. The one or more α-olefin comonomers may, for example, be selected from the group consisting of propylene, 1-butene, 1-hexene, and 1-octene; or in the alternative, from the group consisting of 1-hexene and 1-octene.

In some embodiments, the ethylene/alpha-olefin interpolymer composition has a density of greater than 0.920 g/cc. All individual values and subranges of greater than 0.920 g/cc are disclosed and included herein. For example, the ethylene/alpha-olefin interpolymer composition can have a density of greater than 0.925 g/cc, or greater than 0.930 g/cc, or greater than 0.935 g/cc, or can have a density in the range of 0.925 to 0.965 g/cc, or from 0.930 to 0.965 g/cc, or from 0.925 to 0.960 g/cc, from 0.925 to 0.955 g/cc, from 0.925 to 0.950 g/cc, from 0.930 to 0.960 g/cc, from 0.930 to 0.955 g/cc, or from 0.930 to 0.950 g/cc, where density can be measured in accordance with ASTM D792.

In some embodiments, the ethylene/alpha-olefin interpolymer composition has a melt index (12) of from 10 to 25 g/10 min, where melt index (12) is measured in accordance with ASTM D-1238 at 190° C. at 2.16 kg. All individual values and subranges of from 10 to 25 g/10 min are disclosed and included herein. For example, the ethylene/alpha-olefin interpolymer composition can have a melt index (12) of from 10 to 24 g/10 min, from 10 to 23 g/10 min, from 10 to 22 g/10 min, from 10 to 21 g/10 min, from 10 to 20 g/10 min, from 10 to 18 g/10 min, from 10 to 16 g/10 min, from 12 to 24 g/10 min, from 14 to 25 g/10 min, from 16 to 25 g/10 min, from 18 to 25 g/10 min or from 17 to 25 g/10 min, where melt index (12) is measured in accordance with ASTM D-1238 at 190° C. at 2.16 kg.

In some embodiments, the ethylene/alpha-olefin interpolymer composition has: a density in the range of 0.930 to 0.965 g/cc; a melt index (12) in the range of from 10 to 25 g/10 minutes; a molecular weight distribution, expressed as the ratio of the weight average molecular weight to number average molecular weight (M_{w(GPC)}/M_{n(GPC)}) as determined by GPC in the range of from 1.5 to 2.6; a tan delta at 1 radian/second of at least 45; a low temperature peak and a high temperature peak on an improved comonomer composition distribution (ICCD) elution profile by Crystallization Elution Fractionation between 35° C. to 110° C., and a full width at half maximum of the high temperature peak is less than 6.0° C.

The ethylene/alpha-olefin interpolymer composition can have a ratio of 110/12 of less than 6.9 or less than 6.8 or less than 6.7, wherein 110 is measure according to ASTM D1238, 190° C., 10 kg. Lower 110/12 ratio can indicate lower long chain branching that leads to better spinnability/processability.

The ethylene/alpha-olefin interpolymer composition can have a molecular weight distribution by the method set forth below, expressed as the ratio of the weight average molecular weight to number average molecular weight (M_{w(GPC)}/M_{n(GPC)}) in the range of no more than 2.6 or no more than 2.5 and at least 1.5 or at least 1.7 or at least 2.0. Interpolymer compositions having a molecular weight distribution in this range are believed to have better processability (e.g. fiber spinning) than interpolymers having a higher molecular weight distribution. The ethylene/alpha olefin interpolymer can be characterized by a M_{w(GPC)}/M_{n(GPC)} greater than (I10/I2)−4.63.

The ethylene/alpha-olefin interpolymer composition can have a weight average molecular weight from a lower limit of 15,000 g/mol, 20,000 g/mol, or 30,000 g/mol to an upper limit of 100,000 g/mol 120,000 g/mol, or 150,000 g/mol. The M_{z(GPC)}/M_{w(GPC)} can be less than 3.0 or less than 2.0 and can be more than 1.0. The ethylene/alpha-olefin interpolymer compositions can be a bimodal polymer composition with two peaks in an ICCD elution profile. In that instance, the higher temperature fraction can have a peak position molecular weight of no more than 70,000 g/mol, or no more than 50,000 g/mol. The higher temperature fraction can have a peak position molecular weight of at least 15,000 or at least 20,000 g/mol. The lower temperature fraction can have a peak position molecular weight of at least 30,000 or at least 40,000 or at least 50,000 g/mol. The lower temperature fraction can have a peak position molecular weight of no more than 250,000 or no more than 200,000 or no more than 150,000 g/mol.

The ethylene/alpha-olefin interpolymer composition can be characterized by a tan delta (tan δ) at 1 radian/second of at least 45 or at least 50. The ethylene/alpha-olefin interpolymers can be characterized by a ratio of tan delta at 1 radian/second and 190° C. to tan delta at 100 radians/second and 190° C. of at least 12. These characteristics may be measured by dynamic mechanical spectroscopy (DMS) as described below.

The ethylene/alpha-olefin interpolymer composition can be characterized by at least two distinguishable peaks between 35° C. to 110° C. on the elution profile of improved comonomer composition distribution (ICCD) with a distinct valley (drop of at least 10% compared to the peak height of the smaller peak) between the peaks, wherein the peak positions must be separated by a minimum of 10° C. Each peak is separated by a vertical line at the lowest height point of the adjoining valley. The peak temperature of the lower temperature peak can be at least 50° C. or at least 60° C. and can be less than 90° C. or less than 75° C. The peak temperature of the higher temperature peak can be at least 90° C. or at least 95° C. and can be less than 110° C. or less than 105° C. or less than 100° C.

The weight fraction of the low temperature peak fraction can be at least 25 or at least 30 and less than 65 or less than 60 or less than 55 weight percent based on total weight of the eluted polymer. The weight fraction of the high temperature peak fraction can be at least 35 or at least 40 or at least 45 and no more than 75 weight percent based on total weight of the eluted polymer.

The full width at half maximum of the high temperature peak can be less than 6.0° C. A narrow peak for the high density fraction denotes a narrower composition distribution without ultra-high or ultra-low molecular weight species that could impede spinning performance or create extractables.

The ethylene/alpha-olefin interpolymer composition can have a composition distribution breadth index (CDBI) of less than 0.5 (i.e. less than 50%), less than 0.3 (30%), less than 0.25 (25%), less than 0.22 (22%) or less than 0.2 (20%).

The ethylene/alpha-olefin interpolymer composition can have a comonomer distribution constant (CDC) of less than 100, preferably 30-80.

The ethylene/alpha-olefin interpolymer composition can be characterized by molecular weighted comonomer distribution index (MWCDI) of greater than 0.20, or greater than 0.25 or greater than 0.30 or greater than 0.35, or greater than 0.40 or greater than 0.45 or greater than 0.50. MWCDI is a measure of the slope of comonomer incorporation as a function of molecular weight obtained from conventional gel permeation chromatography. If MWCDI is greater than 0.25 (between a molecular weight range of 20,000 and 200,000 g/mol), the resin structure is viewed as having a significant reverse comonomer incorporation with more comonomer on the higher molecular weight side of the distribution.

The ethylene/alpha olefin interpolymer composition can be characterized by low amounts of long chain branching (LCB). This can be indicated by low zero shear viscosity ratios (ZSVR). Specifically, the ZSVR can be less than 1.35 or no more than 1.30. The ZSVR can be at least 1.10.

The ethylene/alpha olefin interpolymer composition can be characterized by a vinyl saturation number per 1,000,000 carbon atoms of less than 230, or less than 210, or less than 190, or less than 170, or less than 150 as determined by 1H-NMR.

At least 75%, at least 80%, at least 85%, at least 90%, at least 95%, at least 97%, at least 98%, at least 99%, or at least 100% (all percents being by weight based on total weight of the first region) of the second region of the fiber can be the ethylene/alpha olefin interpolymer composition. The remainder of the second region may be additional components such as one or more other polymers and/or one or more additives. The amount of the other polymer may be up to 25%. Potential additives include, but are not limited to, antistatic agents, color enhancers, dyes, lubricants, fillers such as TiO₂ or CaCO₃, opacifiers, nucleators, processing aids, pigments, primary antioxidants, secondary antioxidants, processing aids, UV stabilizers, anti-blocks, slip agents, tackifiers, fire retardants, anti-microbial agents, odor reducer agents, anti-fungal agents, and combinations thereof. The ethylene/alpha olefin interpolymer composition may contain from about 0.01 or from about 0.1 or from about 1 to about 25 or to about 20 or to about 15 or to about 10 percent by the combined weight of such additives, based on the weight of the ethylene/alpha olefin interpolymer composition including such additives.

Any conventional polymerization processes may be employed to produce the ethylene/alpha-olefin interpolymer composition. Such conventional polymerization processes include, but are not limited to, solution polymerization process, using one or more conventional reactors e.g. loop reactors, isothermal reactors, stirred tank reactors, batch reactors in parallel, series, and/or any combinations thereof. Such conventional polymerization processes also include gas-phase, solution or slurry polymerization or any combination thereof, using any type of reactor or reactor configuration known in the art.

In general, the solution phase polymerization process occurs in one or more well-mixed reactors such as one or more isothermal loop reactors or one or more adiabatic reactors at a temperature in the range of from 115 to 250° C.; for example, from 115 to 200° C., and at pressures in the range of from 300 to 1000 psi; for example, from 400 to 750 psi. In one example, in a dual reactor, the temperature in the first reactor is in the range of from 115 to 190° C., for example, from 115 to 150° C., and the second reactor temperature is in the range of 150 to 200° C., for example, from 170 to 195° C. In another example, in a single reactor, the temperature in the reactor is in the range of from 115 to 190° C., for example, from 115 to 150° C. The residence time in solution phase polymerization process is typically in the range of from 2 to 30 minutes; for example, from 10 to 20 minutes. Ethylene, solvent, hydrogen, one or more catalyst systems, optionally one or more co-catalysts, and optionally one or more comonomers are fed continuously to one or more reactors. Exemplary solvents include, but are not limited to, isoparaffins. For example, such solvents are commercially available under the name ISOPAR E from ExxonMobil Chemical Co., Houston, Tex. The resultant mixture of the ethylene/alpha-olefin interpolymer and solvent is then removed from the reactor and the ethylene/alpha-olefin interpolymer composition is isolated. Solvent is typically recovered via a solvent recovery unit, i.e. heat exchangers and vapor liquid separator drum, and is then recycled back into the polymerization system.

The ethylene/alpha-olefin interpolymer composition can be produced via solution polymerization in a dual reactor system, for example a dual loop reactor system, wherein ethylene and optionally one or more α-olefins are polymerized in the presence of one or more catalyst systems. Additionally, one or more co-catalysts may be present.

The ethylene/alpha-olefin interpolymer can be produced via solution polymerization in a single reactor system, for example a single loop reactor system, wherein ethylene and optionally one or more α-olefins are polymerized in the presence of one or more catalyst systems. Two different catalysts can be used in a dual reactor system. One or both of the two different catalysts have the formula (I) as shown below. This allows for manufacture of the bimodal interpolymer compositions as described above.

An exemplary catalyst system suitable for producing the first ethylene/alpha-olefin interpolymer can be a catalyst system comprising a procatalyst component comprising a metal-ligand complex of formula (I):

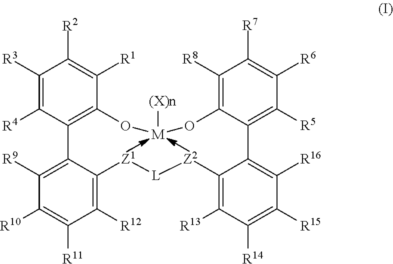

In formula (I), M is a metal chosen from titanium, zirconium, or hafnium, the metal being in a formal oxidation state of +2, +3, or +4; n is 0, 1, or 2; when n is 1, X is a monodentate ligand or a bidentate ligand; when n is 2, each X is a monodentate ligand and is the same or different; the metal-ligand complex is overall charge-neutral; each Z is independently chosen from —O—, —S—, —N(R^{N})—, or —P(R^{P})—; L is (C₁-C₄₀)hydrocarbylene or (C₁-C₄₀)heterohydrocarbylene, wherein independently each R^{N} and R^{P} is (C₁-C₃₀)hydrocarbyl or (C₁-C₃₀)heterohydrocarbyl, and wherein the (C₁-C₄₀)hydrocarbylene has a portion that comprises a 1-carbon atom to 10-carbon atom linker backbone linking the two Z groups in Formula (I) (to which L is bonded) or the (C₁-C₄₀)heterohydrocarbylene has a portion that comprises a 1-atom to 10-atom linker backbone linking the two Z groups in Formula (I), wherein each of the 1 to 10 atoms of the 1-atom to 10-atom linker backbone of the (C₁-C₄₀)heterohydrocarbylene independently is a carbon atom or heteroatom, wherein each heteroatom independently is O, S, S(O), S(O)₂, Si(R^{C})₂, Ge(R^{C})₂, P(R^{C}), or N(R^{C}), wherein independently each R^{C} is (C₁-C₃₀)hydrocarbyl or (C₁-C₃₀)heterohydrocarbyl; R¹ and R⁸ are independently selected from the group consisting of —H, (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —OR^{C}, —SR^{C}, —NO₂, —CN, —CF₃, R^{C}S(O)—, R^{C}S(O)₂—, (R^{C})₂C═N—, R^{C}C(O)O—, R^{C}OC(O)—, R^{C}C(O)N(R^{N})—, (R^{N})₂NC(O)—, halogen, and radicals having formula (II), formula (III), or formula (IV):

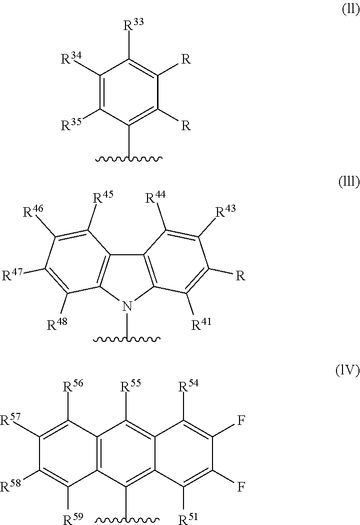

In formulas (II), (III), and (IV), each of R³¹⁻³⁵, R⁴¹⁻⁴⁸, or R⁵¹⁻⁵⁹ is independently chosen from (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —N═CHR^{C}, —OR^{C}, —SR^{C}, —NO₂, —CN, —CF₃, RES(O)—, RCS(O)₂—, (R^{C})₂C═N—, R^{C}C(O)O—, R^{C}OC(O)—, R^{C}C(O)N(R^{N})—, (R^{N})₂NC(O)—, halogen, or —H, provided at least one of R¹ or R⁸ is a radical having formula (II), formula (III), or formula (IV) where R^{C}, R^{N}, and R^{P} are as defined above.

In formula (I), each of R²⁻⁴, R⁵⁻⁷, and R⁹⁻¹⁶ is independently selected from (C₁-C₄₀)hydrocarbyl, (C₁-C₄₀)heterohydrocarbyl, —Si(R^{C})₃, —Ge(R^{C})₃, —P(R^{P})₂, —N(R^{N})₂, —N═CHR^{C}, —OR^{C}, —SR^{C}, —NO₂, —CN, —CF₃, RES(O)—, RES(O)₂—, (R^{C})₂C═N—, R^{C}C(O)O—, R^{C}OC(O)—, R^{C}C(O)N(R^{N})—, (R^{C})₂NC(O)—, halogen, and —H where R^{C}, R^{N}, and R^{P} are as defined above.

The catalyst system comprising a metal-ligand complex of formula (I) may be rendered catalytically active by any technique known in the art for activating metal-based catalysts of olefin polymerization reactions. For example, the comprising a metal-ligand complex of formula (I) may be rendered catalytically active by contacting the complex to, or combining the complex with, an activating co-catalyst. Suitable activating co-catalysts for use herein include alkyl aluminums; polymeric or oligomeric alumoxanes (also known as aluminoxanes); neutral Lewis acids; and non-polymeric, non-coordinating, ion-forming compounds (including the use of such compounds under oxidizing conditions). A suitable activating technique is bulk electrolysis. Combinations of one or more of the foregoing activating co-catalysts and techniques are also contemplated. The term “alkyl aluminum” means a monoalkyl aluminum dihydride or monoalkylaluminum dihalide, a dialkyl aluminum hydride or dialkyl aluminum halide, or a trialkylaluminum. Examples of polymeric or oligomeric alumoxanes include methylalumoxane, triisobutylaluminum-modified methylalumoxane, and isobutylalumoxane.

Lewis acid activators (co-catalysts) include Group 13 metal compounds containing from 1 to 3 (C₁-C₂₀)hydrocarbyl substituents as described herein. Examples of Group 13 metal compounds include tri((C₁-C₂₀)hydrocarbyl)-substituted-aluminum compounds or tri((C₁-C₂₀)hydrocarbyl)-boron compounds. Additional examples of, Group 13 metal compounds are tri(hydrocarbyl)-substituted-aluminum, tri((C₁-C₂₀)hydrocarbyl)-boron compounds, tri((C₁-C₁₀)alkyl)aluminum, tri((C₆-C₁₈)aryl)boron compounds, and halogenated (including perhalogenated) derivatives thereof. Other examples of Group 13 metal compounds are tris(fluoro-substituted phenyl)boranes, tris(pentafluorophenyl)borane. An activating co-catalyst can be a tris((C₁-C₂₀)hydrocarbyl borate (e.g. trityl tetrafluoroborate) or a tri((C₁-C₂₀)hydrocarbyl)ammonium tetra((C₁-C₂₀)hydrocarbyl)borane (e.g. bis(octadecyl)methylammonium tetrakis(pentafluorophenyl)borane). As used herein, the term “ammonium” means a nitrogen cation that is a ((C₁-C₂₀)hydrocarbyl)₄N⁺ a ((C₁-C₂₀)hydrocarbyl)₃N(H)⁺, a ((C₁-C₂₀)hydrocarbyl)₂N(H)₂⁺, (C₁-C₂₀)hydrocarbyl)₂N(H)₃⁺, or N(H)₄⁺, wherein each (C₁-C₂₀)hydrocarbyl, when two or more are present, may be the same or different.

Combinations of neutral Lewis acid activators (co-catalysts) include mixtures comprising a combination of a tri((C₁-C₄)alkyl)aluminum and a halogenated tri((C₆-C₁₈)aryl)boron compound, especially a tris(pentafluorophenyl)borane. Other examples are combinations of such neutral Lewis acid mixtures with a polymeric or oligomeric alumoxane, and combinations of a single neutral Lewis acid, especially tris(pentafluorophenyl)borane with a polymeric or oligomeric alumoxane. Ratios of numbers of moles of (metal-ligand complex):(tris(pentafluoro-phenylborane):(alumoxane) [e.g., (Group 4 metal-ligand complex):(tris(pentafluoro-phenylborane):(alumoxane)] can be from 1:1:1 to 1:10:30, or from 1:1:1.5 to 1:5:10.

The catalyst system comprising the metal-ligand complex of formula (I) may be activated to form an active catalyst composition by combination with one or more co-catalysts, for example, a cation forming co-catalyst, a strong Lewis acid, or combinations thereof. Suitable activating co-catalysts include polymeric or oligomeric aluminoxanes, especially methyl aluminoxane, as well as inert, compatible, noncoordinating, ion forming compounds. Exemplary suitable co-catalysts include, but are not limited to: modified methyl aluminoxane (MMAO), bis(hydrogenated tallow alkyl)methyl, tetrakis(pentafluorophenyl)borate(1⁻) amine, and combinations thereof.

One or more of the foregoing activating co-catalysts can be used in combination with each other. A preferred combination is a mixture of a tri((C₁-C₄)hydrocarbyl)aluminum, tri((C₁-C₄)hydrocarbyl)borane, or an ammonium borate with an oligomeric or polymeric alumoxane compound. The ratio of total number of moles of one or more metal-ligand complexes of formula (I) to total number of moles of one or more of the activating co-catalysts is from 1:10,000 to 100:1. The ratio can be at least 1:5000, or at least 1:1000; and can be no more than 10:1 or no more than 1:1. When an alumoxane alone is used as the activating co-catalyst, preferably the number of moles of the alumoxane that are employed can be at least 100 times the number of moles of the metal-ligand complex of formula (I). When tris(pentafluorophenyl)borane alone is used as the activating co-catalyst, the number of moles of the tris(pentafluorophenyl)borane that can be employed to the total number of moles of one or more metal-ligand complexes of formula (I) range from 0.5:1 to 10:1, from 1:1 to 6:1, or from 1:1 to 5:1. The remaining activating co-catalysts are generally employed in approximately mole quantities equal to the total mole quantities of one or more metal-ligand complexes of formula (I).

### TEST METHODS

### Density

Density is measured in accordance with ASTM D792, Method B, and expressed in grams/cm³ (g/cc or g/cm³).

### Melt Index (12), (110) and Melt Flow Rate

Melt index (12) is measured by ASTM D-1238 at 190° C. at 2.16 kg. Melt index (110) is measured in accordance with ASTM D1238 at 190° C. at 10 kg. Melt flow rate (MFR) is used for polypropylene homopolymers and propylene-ethylene interpolymers and is measured in accordance with ASTM D-1238 at 230° C. at 2.16 kg. The values for melt index (12), (110) and melt flow rate are reported in g/10 min, which corresponds to grams eluted per 10 minutes.

### Dynamic Mechanical Spectroscopy (DMS)

Samples are compression-molded into 3 mm thick×25 mm diameter circular plaque at 177° C. for five minutes, under 10 MPa pressure. The sample are then taken out of the press and placed on a countertop to cool. Constant temperature, frequency sweep measurements are performed on the compression molded plaques with an ARES strain controlled rheometer (TA Instruments), equipped with 25 mm parallel plates, under a nitrogen purge. For each measurement, the rheometer is thermally equilibrated, for at least 30 minutes, prior to zeroing the gap. The sample disk is placed on the plate, and allowed to melt for five minutes at 190° C. The plates are then closed to 2 mm gap, the sample is trimmed, and then the test is started. The method can have an additional five minute delay built in, to allow for temperature equilibration. The experiments are performed at 190° C., over a frequency range from 0.1 to 100 radian/second, at five points per decade interval. The strain amplitude is constant at 10%. The stress response is analyzed in terms of amplitude and phase, from which the storage modulus (G′), loss modulus (G″), complex modulus (G*), dynamic viscosity (η*), and tan δ (or tan delta) are calculated. Tan delta at 1 radian/second and tan delta at 100 radian/second are obtained.

### Improved Comonomer Composition Distribution (ICCD)

The Improved Comonomer Composition Distribution (ICCD) test is performed with Crystallization Elution Fractionation instrumentation (CEF) (PolymerChar, Spain) equipped with IR-5 detector (PolymerChar, Spain) and two-angle light scattering detector Model 2040 (Precision Detectors, currently Agilent Technologies). The ICCD column is packed with gold coated nickel particles (Bright 7GNM8-NiS, Nippon Chemical Industrial Co.) in a 15 cm (length)×¼″ (ID) stainless tubing. The column packing and conditioning are with a slurry method according to the reference (Cong, R.; Parrott, A.; Hollis, C.; Cheatham, M. WO2017040127A1). The final pressure with trichlorobenzene (TCB) slurry packing is 150 bars. The column is installed just before IR-5 detector in the detector oven. Orthodichlorobenzene (ODCB, 99% anhydrous grade or technical grade) is used as eluent. Silica gel 40 (particle size 0.2˜0.5 mm, catalogue number 10181-3) is obtained from EMD Chemicals and can be used to dry ODCB solvent The ICCD instrument is equipped with an autosampler with nitrogen (N₂) purging capability. ODCB is sparged with dried N₂ for one hour before use. Sample preparation is done with autosampler at 4 mg/ml (unless otherwise specified) under shaking at 160° C. for 1 hour. The injection volume is 300 μl. The temperature profile of ICCD is: crystallization at 3° C./min from 105° C. to 30° C., then thermal equilibrium at 30° C. for 2 minutes (including Soluble Fraction Elution Time being set as 2 minutes), followed by heating at 3° C./min from 30° C. to 140° C. The flow rate during elution is 0.50 ml/min. Data are collected at one data point/second. Column temperature calibration can be performed by using a mixture of the reference material linear homopolymer polyethylene (having zero comonomer content, melt index (12) of 1.0 g/10 min, polydispersity M_{w(GPC)}/M_{n(GPC)} approximately 2.6 by conventional gel permeation chromatography, 1.0 mg/ml) and Eicosane (2 mg/ml) in ODCB. ICCD temperature calibration consists of four steps: (1) Calculating the delay volume defined as the temperature offset between the measured peak elution temperature of Eicosane minus 30.00° C.; (2) Subtracting the temperature offset of the elution temperature from the ICCD raw temperature data. It is noted that this temperature offset is a function of experimental conditions, such as elution temperature, elution flow rate, etc.; (3) Creating a linear calibration line transforming the elution temperature across a range of 30.00° C. and 140.00° C. so that the linear homopolymer polyethylene reference has a peak temperature at 101.0° C., and Eicosane has a peak temperature of 30.0° C.; (4) For the soluble fraction measured isothermally at 30° C., the elution temperature below 30.0° C. is extrapolated linearly by using the elution heating rate of 3° C./min according to the reference (Cerk and Cong et al., U.S. Pat. No. 9,688,795).

The comonomer content calibration curve (comonomer content in mole percent versus elution temperature (T)) of ICCD is constructed by using 12 reference materials (a linear ethylene homopolymer and 11 ethylene-octene random copolymers made with single site metallocene catalyst, having a weight average molecular weight ranging from 35,000 to 128,000 g/mol) with known comonomer contents. All of these reference materials are analyzed in the same way as specified previously at 4 mg/mL. The comonomer content in mole percent and its peak temperature on the elution curve follows

$$ln ( 1 - comonomer content ( mol \% ) ) = \qquad Eq . 1$$

$$- \frac{208.328 ( ° C . )}{273.15 ( ° C . ) + T ( ° C . )} + 0.55846$$

### Determination of Peaks and Full Width at Half Maximum on the ICCD Elution Profile

A single baseline is subtracted from the IR measurement signal in order to create a relative mass-elution profile plot starting and ending at zero relative mass at its lowest and highest elution temperatures (typically between 35° C. and 119° C.). For convenience, this is presented as a normalized quantity with respect to an overall area equivalent to 1. In the relative mass-elution profile plot from ICCD, a weight fraction (w_{T}(T)) at each temperature (T) can be obtained. The profile (w_{T}(T) vs. T) is from 35.0° C. to 119.0° C. with a temperature step increase of 0.200° C. from the ICCD, and follows

$${\int }_{35.}^{119.} {w}_{T} ( T ) dT = 1 \qquad Eq . 2$$

On the w_{T}(T) vs. T elution profile, a single peak is defined as a curve with one Highest Point in the middle and two Lowest Points on two sides (lower temperature side and higher temperature side). Both heights of the two Lowest Points need to be lower than the height of the Highest Point by at least 10%. If one or both of the Lowest Points have a height less than 10% lower than the height of the Highest Point, i.e. one or both of the Lowest Points have a height greater than 90% of the height of the Highest Point, such a curve is considered a shoulder associated with another peak, but is not a peak itself. Each separate peak is then measured for width in degree C. at 50% of the maximum height of that peak in the w_{T}(T) vs. T elution profile plot. This width is called the full width at half maximum of the peak.

If the ICCD elution profile has multiple peaks, the separation points (T separation) between the peaks can be defined as the Lowest Points of the adjacent two peaks. The weight fraction of the nth peak (WT_{peak n}) can be calculated according to the following equations:

$${WT}_{peak 1} = {\int }_{35.}^{{T}_{separation , 1}} {w}_{T} ( T ) dT \qquad ( Eq . 3 a )$$

$${WT}_{peak 2} = {\int }_{{T}_{separation , 1}}^{{T}_{separation , 2}} {w}_{T} ( T ) dT \qquad ( Eq . 3 b )$$

$${WT}_{peak n} = {\int }_{{T}_{separation , n - 1}}^{119.} {w}_{T} ( T ) dT \qquad ( Eq . 3 c )$$

where the peak 1, peak 2, . . . , and peak n are the peaks in the order from low temperature to high temperature, and the T_{separation, n} is the separation point between the n peak and n+1 peak.

Full width at half maximum is defined as the temperature difference between the first intersection of the front temperature and the first intersection of the rear temperature at half of the maximum peak height of that individual peak. The front temperature at the half of the maximum peak is searched forward from 35.0° C., while the rear temperature at the half of the maximum peak is searched backward from 119.0° C.

### Comonomer Distribution Constant (CDC)

Comonomer distribution constant (CDC) is calculated from w_{T}(T) vs. T elution profile by ICCD according to the following steps:
(1) Obtain w_{T}(T) vs. T elution profile from ICCD in the range from 35.0° C. to 119.0° C. with a temperature step increase of 0.200° C. Total weight fraction from 35° C. to 119° C. is normalized to 1.0 and should follow Equation 2.
(2) Calculate the median temperature (T_{median}) at cumulative weight fraction of 0.500, according to the following formula:

$${\int }_{35.0}^{{T}_{median}} {w}_{T} ( T ) dT = 0.5 \qquad Eq \text{.4}$$

(3) Calculate the corresponding median comonomer content in mole % (C_{median}) at the median temperature (T_{median}) by using comonomer content calibration curve according to Equation 4.
(4) Composition Distribution Breadth Index (CDBI) is defined as the total weight fraction of polymer chains with a comonomer content ranging from 0.5*C_{median} to 1.5*C_{median} from 35.0° C. to 119.0° C. Find the corresponding temperature T1 for 0.5*C_{median} and the corresponding temperature T2 for 1.5*C_{median} based on Equation 2. Composition Distribution Breadth Index (CDBI) can be obtained from the weight fraction (w_{T}(T)) vs. temperature (T) plot between T1 and T2 as θ_{T2}^{T1}w_{T}(T)dT. If T_{median} is higher than 98.0° C., Composition Distribution Breadth Index (CDBI) is defined as 0.95;
(5) Obtain the temperature at the maximum peak height (Tₚ) from w_{T}(T) vs. T profile of ICCD by searching each data point for the highest peak from 35.0° C. to 119.0° C. (if the two peaks are identical in height, then the lower temperature peak is selected); When the difference in the peak temperatures is equal to or greater than 1.1 times of the sum of full width at half maximum of each peak, the Half Width of the interpolymer composition is calculated as the arithmetic average of the full width at half maximum of each peak. If the difference in the peak temperatures is less than 1.1 times of the sum of full width at half maximum of each peak, the Half Width of the interpolymer composition is defined as the full width at half maximum of the highest temperature peak.
(6) Calculate the standard deviation of temperature (Stdev) according to the following formula:

$$Stdev = \sqrt[2]{{\int }_{35}^{1 \; 19} {( T - {T}_{p} )}^{2} \times {w}_{T} ( T ) dT} \qquad Eq . 5$$

(7) Comonomer distribution constant (CDC) is calculated from the following equation:

$$CDC = \frac{Composition Distribution Breath Index}{Half Width {/}_{Stdev}} \times 100 \qquad Eq . 6$$

Conventional Gel Permeation Chromatography (conventional GPC) and MWCDI

The chromatographic system consists of a PolymerChar GPC-IR (Valencia, Spain) high temperature GPC chromatograph equipped with an internal IR5 infra-red detector (IR5). The autosampler oven compartment is set at 160° C. and the column compartment is set at 150° C. The columns used are 4 Agilent “Mixed A” 30 cm 20-micron linear mixed-bed columns. The chromatographic solvent used is 1,2,4 trichlorobenzene and contains 200 ppm of butylated hydroxytoluene (BHT). The solvent source is nitrogen sparged. The injection volume used is 200 microliters and the flow rate is 1.0 milliliter/minute.

Calibration of the GPC column set is performed with at least 20 narrow molecular weight distribution polystyrene standards with molecular weights ranging from 580 to 8,400,000 g/mol and are arranged in 6 “cocktail” mixtures with at least a decade of separation between individual molecular weights. The standards are purchased from Agilent Technologies. The polystyrene standards are prepared at 0.025 grams in 50 milliliters of solvent for molecular weights equal to or greater than 1,000,000 g/mol, and 0.05 grams in 50 milliliters of solvent for molecular weights less than 1,000,000 g/mol. The polystyrene standards are dissolved at 80° C. with gentle agitation for 30 minutes. The polystyrene standard peak molecular weights are converted to ethylene/alpha-olefin interpolymer molecular weights using the following equation (as described in Williams and Ward, J. Polym. Sci., Polym. Let., 6, 621 (1968)):

$${M}_{polyethylene} = A \times {( {M}_{polystyrene} )}^{B} \qquad ( Eq . 7 )$$

where M is the molecular weight, A has a value of 0.4315 and B is equal to 1.0.

A fifth order polynomial is used to fit the respective ethylene/alpha-olefin interpolymer-equivalent calibration points. A small adjustment to A (from approximately 0.39 to 0.44) is made to correct for column resolution and band-broadening effects such that NIST standard NBS 1475 is obtained at a molecular weight of 52,000 g/mol.

The total plate count of the GPC column set is performed with Eicosane (prepared at 0.04 g in 50 milliliters of TCB and dissolved for 20 minutes with gentle agitation). The plate count (Equation 8) and symmetry (Equation 9) are measured on a 200 microliter injection according to the following equations:

$$Plate Count = 5.54 \times {( \frac{{RV}_{Peak Max}}{Peak Width at half height} )}^{2} \qquad ( Eq . 8 )$$

where RV is the retention volume in milliliters, the peak width is in milliliters, the Peak Max is the maximum height of the peak, and half height is one half of the height of the peak maximum.

$$Symmetry = \frac{( Rear Peak {RV}_{one tenth height} - {RV}_{Peak max} )}{( {RV}_{Peak max} - Front Peak {RV}_{one tenth height} )} \qquad ( Eq . 9 )$$

where RV is the retention volume in milliliters and the peak width is in milliliters, Peak max is the maximum position of the peak, one tenth height is one tenth of the height of the peak maximum, and where rear peak refers to the peak tail at later retention volumes than the Peak max and where front peak refers to the peak front at earlier retention volumes than the Peak max. The plate count for the chromatographic system should be greater than 22,000 and symmetry should be between 0.98 and 1.22.

Samples are prepared in a semi-automatic manner with the PolymerChar “Instrument Control” Software, wherein the samples are weight-targeted at 2 mg/ml, and the solvent (contained 200 ppm BHT) is added to a pre nitrogen-sparged septa-capped vial, via the PolymerChar high temperature autosampler. The samples are dissolved for 3 hours at 160° C. under “low speed” shaking.

The calculations of M_{n(GPC)}, M_{w(GPC)}, and M_{z(GPC)} are based on GPC results using the internal IR5 detector (measurement channel) of the PolymerChar GPC-IR chromatograph according to Equations 11a-c, using PolymerChar GPCOne™ software, the baseline-subtracted IR chromatogram at each equally-spaced data collection point i (IRᵢ) and the ethylene/alpha-olefin interpolymer equivalent molecular weight obtained from the narrow standard calibration curve for the point i (M_{polyethylene,i} in g/mol) from Equation 7. Subsequently, a GPC molecular weight distribution (GPC-MWD) plot (wt_{GPC}(lgMW) vs. lgMW plot, where wt_{GPC}(lgMW) is the weight fraction of the interpolymer molecules with a molecular weight of lgMW) can be obtained. Molecular weight is in g/mol and wt_{GPC}(lgMW) follows the Equation 10.

$$\int {wt}_{GPC} ( lg MW ) d lg MW = 1. \qquad ( Eq . 10 )$$

Number-average molecular weight M_{n(GPC)}, weight-average molecular weight M_{w(GPC)} and z-average molecular weight M_{z(GPC)} can be calculated as the following equations.

$${Mn}_{( GPC )} = \frac{{\sum }^{i} {IR}_{i}}{{\sum }^{i} ( {IR}_{i} / {M}_{polyethylene {,}_{i}} )} \qquad ( Eq . 11 a )$$

$${Mw}_{( GPC )} = \frac{{\sum }^{i} ( {IR}_{i} * {M}_{polyethylene {,}_{i}} )}{{\sum }^{i} {IR}_{i}} \qquad ( Eq . 11 b )$$

$${Mz}_{( GPC )} = \frac{{\sum }^{i} ( {IR}_{i} * {M}_{polyethylene {,}_{i}}^{2} )}{{\sum }^{i} ( {IR}_{i} * {M}_{polyethylene {,}_{i}} )} \qquad ( Eq . 11 c )$$

In order to monitor the deviations over time, a flow rate marker (decane) is introduced into each sample via a micropump controlled with the PolymerChar GPC-IR system. This flow rate marker (FM) is used to linearly correct the pump flow rate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flow rate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flow rate (with respect to the narrow standards calibration) is calculated as Equation 12. Processing of the flow marker peak is done via the PolymerChar GPCOne™ Software. Acceptable flow rate correction is such that the effective flowrate should be within 0.5% of the nominal flowrate.

$$( Eq . 12 )$$

$$Flow {rate}_{effective} = Flow {rate}_{nominal} \times ( RV ( {FM}_{calibrated} ) / RV ( {FM}_{Sample} ) )$$

A calibration for the IR5 detector ratioing can be performed using at least eight ethylene/alpha-olefin interpolymer standards (one polyethylene homopolymer and seven ethylene/octene copolymers) of known short chain branching (SCB) frequency (measured by the 13C NMR Method), ranging from homopolymer (0 SCB/1000 total C) to approximately 50 SCB/1000 total C, where total C=carbons in backbone+carbons in branches. Each standard has a weight-average molecular weight from 36,000 g/mol to 126,000 g/mol, as determined by GPC. Each standard has a molecular weight distribution (M_{w(GPC)}/M_{n(GPC)}) from 2.0 to 2.5, as determined by GPC. The “IR5 Area Ratio (or “IR5 Methyl Channel Area/IR5 Measurement Channel Area”)” of “the baseline-subtracted area response of the IR5 methyl channel sensor” to “the baseline-subtracted area response of IR5 measurement channel sensor” (standard filters and filter wheel as supplied by PolymerChar: Part Number IR5_FWM01 included as part of the GPC-IR instrument) is calculated for each of the “SCB” standards. A linear fit of the SCB frequency versus the “IR5 Area Ratio” is constructed in the form of the following equation:

$$SCB / 1000 total C = {A}_{0} + [ {A}_{1} \times ( IR {5}_{Methyl Channel Area} / IR {5}_{Measurement Channel Area} ) ] \qquad ( Eq . 13 )$$

where A₀ is the SCB/1000 total C intercept at an “IR5 Area Ratio” of zero, and A1 is the slope of the SCB/1000 total C versus “IR5 Area Ratio” and represents the increase in the SCB/1000 total C as a function of “IR5 Area Ratio.”

A series of linear baseline-subtracted chromatographic heights for the chromatogram generated by the “IR5 methyl channel sensor” are established as a function of column elution volume, to generate a baseline-corrected chromatogram (methyl channel). A series of linear baseline-subtracted chromatographic heights for the chromatogram generated by the “IR5 measurement channel” are established as a function of column elution volume, to generate a base-line-corrected chromatogram (measurement channel).

The “IR5 Height Ratio” of “the baseline-corrected chromatogram (methyl channel)” to “the baseline-corrected chromatogram (measurement channel)” is calculated at each column elution volume index (each equally-spaced index, representing 1 data point per second at 1 ml/min elution) across the sample integration bounds. The “IR5 Height Ratio” is multiplied by the coefficient A1, and the coefficient A0 is added to this result, to produce the predicted SCB frequency of the sample. The result is converted into mole percent comonomer as follows in Equation 14:

$$( Eq . 14 )$$

$$Mole Percent Comonomer = \{ {SCB}_{f} / [ {SCB}_{f} + ( ( 1 \; 000 - {SCB}_{f} * Length of comonomer ) / 2 ) ] \} * 100 ,$$

where “SCB_{f}” is the “SCB per 1000 total C”, and the “Length of comonomer” is the number of carbons of the comonomer, e.g. 8 for octene, 6 for hexene, and so forth.

Each elution volume index is converted to a molecular weight value (Mwi) using the method of Williams and Ward (described above). The “Mole Percent Comonomer” is plotted as a function of lg(Mwi), and the slope is calculated between Mwi of 20,000 and Mwi of 200,000 g/mol (end group corrections on chain ends are omitted for this calculation). Linear regression is used to calculate the slope between, and including, Mwi from 20,000 to 200,000 g/mol, wherein the height of the concentration chromatogram (wt_{GPC}(lgMW) vs. lgMW plot) is at least 10% of the peak height of the chromatogram. This slope is defined as the molecular weighted comonomer distribution index (MWCDI).

### Zero-Shear Viscosity Ratio (ZSVR)

Zero-shear viscosity ratio is defined as the ratio of the zero-shear viscosity (ZSV) of the branched polyethylene material to the ZSV of a linear polyethylene material (see ANTEC proceeding below) at the equivalent weight average molecular weight (M_{w(GPC)}), according to the following equation:

$$ZSVR = \frac{{η}_{0 B}}{{η}_{0 L}} = \frac{{η}_{0 B}}{2.29 \times 1 {0}^{- 15} Pa \cdot sec \cdot {( \frac{g}{mol} )}^{- 3.65} \times {M}_{w ( GPC )}^{3.65}} . \qquad ( Eq . 15 )$$

The ZSV value of the interpolymer (η_{0B}) is obtained from creep test, at 190° C., via the method described below. The M_{w(GPC)} value is determined by the conventional GPC method (Equation 11b), as discussed above. The correlation between ZSV of linear polyethylene (η_{0L}) and its M_{w(GPC)} is established based on a series of linear polyethylene reference materials. A description for the ZSV-M_{w(GPC)} relationship can be found in the ANTEC proceeding: Karjala et al., Detection of Low Levels of Long-chain Branching in Polyolefins, Annual Technical Conference-Society of Plastics Engineers (2008), 66^{th} 887-891.

### Creep Test

The ZSV value of the interpolymer (η_{0B}) is obtained from a constant stress rheometer creep test at 190° C. in a nitrogen environment using DHR, TA Instrument. The samples are subjected to flow between two 25 mm diameter plate fixtures positioned parallel to each other. Samples are prepared by compression molding pellets of the interpolymer into circular plaques of about 1.5-2.0 mm thick. The plaques are further cut into 25 mm diameter disks and sandwiched between the plate fixtures of the TA Instrument. The oven on the TA instrument is closed for 5 minutes after sample loading and before setting the gap between the plate fixtures to 1.5 mm, opening the oven to trim the edges of the sample, and reclosing the oven. A logarithmic frequency sweep between 0.1 to 100 radians/second at 190° C., 300 seconds of soak time, and 10% strain is conducted before and after the creep test to determine whether the sample has degraded. A constant low shear stress of 20 Pa is applied for all of the samples, to ensure that the steady state shear rate is low enough to be in the Newtonian region. Steady state is determined by taking a linear regression for the data in the last 10% time window of the plot of “lg (J(t)) vs. lg(t)”, where J(t) is creep compliance and t is creep time. If the slope of the linear regression is greater than 0.97, steady state is considered to be reached, then the creep test is stopped. In all cases in this study, the slope meets the criterion within one hour. The steady state shear rate is determined from the slope of the linear regression of all of the data points, in the last 10% time window of the plot of “& vs. t”, where & is strain. The zero-shear viscosity is determined from the ratio of the applied stress to the steady state shear rate.

### ¹H NMR Method

A stock solution (3.26 g) is added to 0.133 g of the polymer sample in 10 mm NMR tube. The stock solution is a mixture of tetrachloroethane-d2 (TCE) and perchloroethylene (50:50 in weight) with 0.001M Cr³⁺. The solution in the tube is purged with N₂, for 5 minutes, to reduce the amount of oxygen. The capped sample tube is left at room temperature, overnight, to swell the polymer sample. The sample is dissolved at 110° C. with periodic vortex mixing. The samples are free of the additives that may contribute to unsaturation, for example, slip agents such as erucamide. Each 1H NMR analysis is run with a 10 mm cryoprobe, at 120° C., on Bruker AVANCE 400 MHz spectrometer.

Two experiments are run to measure unsaturation: one control and one double presaturation experiment. For the control experiment, the data are processed with an exponential window function with 1 Hz line broadening and the baseline is corrected from about 7 to −2 ppm. The signal from residual 1H of TCE is set to 100, the integral (Itotal) from about −0.5 to 3 ppm is used as the signal from the whole polymer in the control experiment. The number of total carbons, NC, in the polymer is calculated as follows in Equation 16:

$$NC = {I}_{total} / 2 \qquad ( Eq . 16 )$$

For the double presaturation experiment, the data are processed with an exponential window function with 1 Hz line broadening, and the baseline is corrected from about 6.6 to 4.5 ppm. The signal from residual 1H of TCE is set to 100, and the corresponding integrals for unsaturations (I_{vinylene}, I_{trisubstituted}, I_{vinyl} and I_{vinylidene}) are integrated. It is well known to use NMR spectroscopic methods for determining polyethylene unsaturation, for example see Busico, V., et al., Macromolecules, 2005, 38, 6988. The number of unsaturation unit for vinylene, trisubstituted, vinyl and vinylidene are calculated as follows:

$${N}_{vinylene} = {I}_{vinylene} / 2 , \qquad ( Eq . 17 )$$

$${N}_{trisubstituted} = {I}_{trisubstitute} , \qquad ( Eq . 18 )$$

$${N}_{vinyl} = {I}_{vinyl} / 2 , \qquad ( Eq . 19 )$$

$${N}_{vinylidene} = {I}_{vinylidene} / 2. \qquad ( Eq . 20 )$$

The unsaturation units per 1,000 total carbons, i.e., all polymer carbons including backbone and branches, are calculated as:

$${N}_{vinylene} / 1 , 000 C = ( {N}_{vinylene} / NC ) * 1 , 000 , \qquad ( Eq . 21 )$$

$${N}_{trisubstituted} / 1 , 000 C = ( {N}_{trisubstituted} / NC ) * 1 , 000 , \qquad ( Eq . 22 )$$

$${N}_{vinyl} / 1 , 000 C = ( {N}_{vinyl} / {NCH}_{2} ) * 1 , 000 , \qquad ( Eq . 23 )$$

$${N}_{vinylidene} / 1 , 000 C = ( {N}_{vinylidene} / NC ) * 1 , 0. \qquad ( Eq . 24 )$$

The chemical shift reference is set at 6.0 ppm for the 1H signal from residual proton from TCE-d2. The control is run with a ZG pulse, NS=4, DS=12, SWH=10,000 Hz, AQ=1.64 s, D1=14 s. The double presaturation experiment is run with a modified pulse sequence, with O1P=1.354 ppm, O2P=0.960 ppm, PL9=57 db, PL21=70 db, NS=100, DS=4, SWH=10,000 Hz, AQ=1.64 s, D1=1 s (where D1 is the presaturation time), D13=13 s.

### ¹³C NMR Method

The samples are prepared by adding approximately 3 g of a 50/50 mixture of tetrachloroethane-d2/orthodichlorobenzene, containing 0.025 M Cr(AcAc)₃, to a 0.25 g polymer sample in a Norell 1001-7 10 mm NMR tube. Oxygen is removed from the sample by purging the tube headspace with nitrogen. The samples are then dissolved and homogenized by heating the tube and its contents to 150° C. using a heating block and heat gun. Each sample is visually inspected to ensure homogeneity. Samples are thoroughly mixed immediately prior to analysis, and are not allowed to cool before insertion into the heated NMR probe. This is necessary to ensure the sample is homogeneous and representative of the whole. All data are collected using a Bruker 400 MHz spectrometer equipped with a Bruker cryoprobe. The data are acquired using a 6 second pulse repetition delay, 90-degree flip angles, and inverse gated decoupling with a sample temperature of 120° C. All measurements are made on non-spinning samples in locked mode. Samples are allowed to thermally equilibrate for 7 minutes prior to data acquisition. The 13C NMR chemical shifts are internally referenced to the EEE triad at 30 ppm.

C13 NMR comonomer Content: It is well known to use NMR spectroscopic methods for determining polymer composition. ASTM D 5017-96; J. C. Randall et al., in “NMR and Macromolecules” ACS Symposium series 247; J. C. Randall, Ed., Am. Chem. Soc., Washington, D.C., 1984, Ch. 9; and J. C. Randall in “Polymer Sequence Determination”, Academic Press, New York (1977) provide general methods of polymer analysis by NMR spectroscopy.

### Curvature

The amount of curvature is measured via optical microscopy. The amount of curvature is calculated based on the inverse of the radius of the helix formed by the fiber. This is equal to the radius of the circle formed by projection of the helix formed by the fiber on a surface perpendicular to it. Average value of at least 5 measurements is reported. Measurements are reported in units of 1/millimeter (mm-1).

### Cross-Section Images for Measuring the Centroid Off-Set

SEM or AFM analysis can be used to gather cross-section images of fibers. In the SEM analysis, approximately ten stained fibers were mounted in epoxy, cured overnight in the same oven, and cryogenically polished to expose the fiber in cross section. For polishing, a Leica UC7 Ultramicrotome was operated at −120° C. and fitted with diamond knives. The polished fibers were mounted to a SEM sample stub, coated with 25 seconds of sputtered Iridium, and examined in the scanning electron microscope (SEM). FEI Nova SEM operated at 5 kV of accelerating voltage, spot size of 4.5, the #5 objective aperture, and a working distance ˜12 mm has been used and all images are captured from secondary electron emissions using SEM.

In the AFM analysis, Fibers were embedded in epoxy and polished under cryogenic conditions using a Leica UCT/FCS microtome operated at −120° C. for AFM analysis. Topography and phase images were captured at ambient temperature by using a Bruker Icon AFM system with a MikroMasch probe. The probe has a spring constant of 40 N/m and a resonant frequency in the vicinity of 170 kHz. An imaging frequency of 0.5-2 Hz is used with a set point ratio of approximately 0.8.

### Examples

### Production of Ethylene/Alpha-Olefin Interpolymer Compositions

Developmental resins (“Resin 1”, “Resin 2”) are prepared according to the following process and tables.

All raw materials (ethylene monomer and 1-octene comonomer) and the process solvent (a narrow boiling range high-purity isoparaffinic solvent, product name Isopar-E commercially available from ExxonMobil Chemical) are purified with molecular sieves before introduction into the reaction environment. Hydrogen is supplied pressurized as a high purity grade and is not further purified. The reactor ethylene feed stream is pressurized via a mechanical compressor to above reaction pressure. The solvent and comonomer feed are pressurized via a pump to above reaction pressure. The individual catalyst components are manually batch diluted to suitable component concentrations with purified solvent and pressured to above reaction pressure. All reaction feed flows are measured with mass flow meters and independently controlled with computer automated valve control systems.

A two reactor system is used in a series configuration. Each continuous solution polymerization reactor consists of a liquid full, non-adiabatic, isothermal, circulating, loop reactor which mimics a continuously stirred tank reactor (CSTR) with heat removal. Independent control of all fresh solvent, ethylene, hydrogen, and catalyst component feeds is possible. The total fresh feed stream to each reactor (solvent, ethylene, 1-octene, and hydrogen) is temperature controlled to maintain a single solution phase by passing the feed stream through a heat exchanger. The total fresh feed to each polymerization reactor is injected into the reactor at two locations with approximately equal reactor volumes between each injection location. The fresh feed is controlled with each injector receiving half of the total fresh feed mass flow. The catalyst components are injected into the polymerization reactor through specially designed injection stingers. The primary catalyst (pre-catalyst) component feed is computer controlled to maintain each reactor ethylene conversion at the specified targets. The cocatalyst components are fed based on calculated specified molar ratios to the primary catalyst (pre-catalyst) component. Immediately following each reactor feed injection location, the feed streams are mixed with the circulating polymerization reactor contents with static mixing elements. The contents of each reactor are continuously circulated through heat exchangers responsible for removing much of the heat of reaction and with the temperature of the coolant side responsible for maintaining an isothermal reaction environment at the specified temperature. Circulation around each reactor loop is provided by a pump.

In dual series reactor configuration, the effluent from the first polymerization reactor (containing solvent, ethylene, 1-octene, hydrogen, catalyst components, and polymer) exits the first reactor loop and is added to the second reactor loop.

The second reactor effluent enters a zone where it is deactivated with the addition of and reaction with water. Following catalyst deactivation and additive addition, the reactor effluent enters a devolatization system where the polymer is removed from the non-polymer stream. The isolated polymer melt is pelletized and collected. The non-polymer stream passes through various pieces of equipment which separate most of the ethylene which is removed from the system. Most of the solvent and unreacted 1-octene is recycled back to the reactor after passing through a purification system. A small amount of solvent and 1-octene is purged from the process.

The reactor stream feed data flows that correspond to the values in Table 1 are used to produce the examples. The data are presented such that the complexity of the solvent recycle system is accounted for and the reaction system can be treated more simply as a once through flow diagram. Catalyst components used are referenced in Table 2.

Each of the polymers made is tested for various properties according to the methods set forth above.

TABLE 1
Production Conditions for Resin 1 and Resin 2

| | | Resin 1 | Resin 2 |
|---|---|---|---|
| First Reactor Feed Solvent/ | g/g | 3.3 | 3.1 |
| Ethylene Mass Flow Ratio | | | |
| First Reactor Feed 1-octene/ | g/g | 0.11 | 0.33 |
| Ethylene Mass Flow Ratio | | | |
| First Reactor Feed Hydrogen/ | g/g | 2.3E−04 | 3.3E−04 |
| Ethylene Mass Flow Ratio | | | |
| First Reactor Temperature | ° C. | 160 | 160 |
| First Reactor Pressure (gauge) | Pa | 725 | 580 |
| First Reactor Ethylene Conversion | % | 94.6 | 89.7 |
| First Reactor Catalyst Type | Type | Pro-catalyst 1 | Pro-catalyst 1 |
| First Reactor Co-Catalyst 1 Type | Type | Co-catalyst 1 | Co-catalyst 1 |
| First Reactor Co-Catalyst 2 Type | Type | Co-catalyst 2 | Co-catalyst 2 |
| First Reactor Co-Catalyst 1 | Ratio | 1.1 | 1.2 |
| to Catalyst Molar Ratio | | | |
| (B to Zr ratio) | | | |
| First Reactor Co-Catalyst 2 | Ratio | 20.5 | 39.2 |
| to Catalyst Molar Ratio | | | |
| (Al to Zr ratio) | | | |
| First Reactor Residence Time | min | 17.9 | 17.8 |
| Second Reactor Feed Solvent/ | g/g | 2.5 | 2.5 |
| Ethylene Mass Flow Ratio | | | |
| Second Reactor Feed 1-octene/ | g/g | 0.044 | 0.134 |
| Ethylene Mass Flow Ratio | | | |
| Second Reactor Feed Hydrogen/ | g/g | 4.7E−04 | 6.3E−04 |
| Ethylene Mass Flow Ratio | | | |
| Second Reactor Temperature | ° C. | 195 | 195 |
| Second Reactor Pressure (gauge) | Pa | 725 | 580 |
| Second Reactor Ethylene Conversion | % | 91.9 | 91.6 |
| Second Reactor Catalyst Type | Type | Pro-catalyst 2 | Pro-catalyst 2 |
| Second Reactor Co-Catalyst 1 Type | Type | Co-catalyst 1 | Co-catalyst 1 |
| Second Reactor Co-Catalyst 2 Type | Type | Co-catalyst 2 | Co-catalyst 2 |
| Second Reactor Co-Catalyst 1 | mol/mol | 7.6 | 5.5 |
| to Catalyst Molar Ratio | | | |
| (B to Zr ratio) | | | |
| Second Reactor Co-Catalyst 2 | mol/mol | 1387.0 | 2248.8 |
| to Catalyst Molar Ratio | | | |
| (Al to Zr ratio) | | | |
| Second Reactor Residence Time | min | 7.4 | 7.5 |

TABLE 2
Catalyst Systems for Resin 1 and Resin 2

| | |
|---|---|
| Pro-Catalyst 1 | 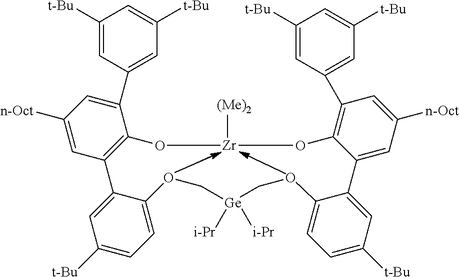 |
| Pro-Catalyst 2 | 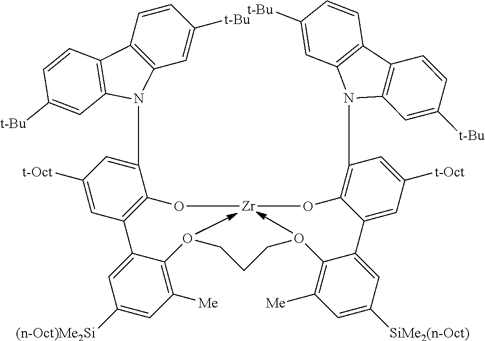 |
| Co-catalyst 1 | bis(hydrogenated tallow alkyl)methylammonium |
| | tetrakis(pentafluorophenyl)borate(1-) |
| Co-catalyst 2 | Aluminoxanes, iso-Bu Me, branched, cyclic and linear; modified methyl |
| | aluminoxane |

TABLE 3
Properties of Resin 1 and Resin 2

| Interpolymer | Unit | Resin 1 | Resin 2 |
|---|---|---|---|
| Density | g/cm³ | 0.945 | 0.935 |
| I2 | g/10 | 21 | 21 |
| | min | | |
| I10/I2 | | 6.2 | 6.2 |
| ZSVR | | 1.2 | 1.2 |
| Tan δ at 1 rad/s | | 75.6 | 89.0 |
| Tan δ at 100 rad/s | | 3.5 | 3.7 |
| Ratio of Tan δ at 1 | | 21.5 | 24.1 |
| rad/s to Tan δ at 100 | | | |
| rad/s | | | |
| Vinyl unsaturation | per 10⁶ | 127 | 143 |
| | total | | |
| | carbons | | |
| M_{w(GPC)}/M_{n(GPC)} | | 2.4 | 2.3 |
| M_{z(GPC)}/M_{w(GPC)} | | 2.0 | 1.9 |
| M_{w(GPC)} | g/mol | 49080 | 46766 |
| MWCDI | | 0.65 | 1.90 |
| CDC | | 52 | 54 |
| CDBI | % | 19 | 21 |
| Peak temperature of | ° C. | 88.1 | 73.4 |
| low temperature | | | |
| peak | | | |
| Weight fraction of | % | 43.1 | 38.3 |
| low temperature | | | |
| peak | | | |
| Peak temperature of | ° C. | 99.8 | 97.6 |
| high temperature | | | |
| peak | | | |
| Weight fraction of | % | 56.9 | 61.7 |
| high temperature | | | |
| peak | | | |
| Full width at half | ° C. | 3.6 | 4.2 |
| maximum of high | | | |
| temperature peak | | | |

In addition to Resin 1 and Resin 2, the following materials are used in the examples.

Exxon PP 3155, a polypropylene homopolymer having a density of 0.900 g/cc and a melt flow rate of 36 g/10 min, is commercially available from ExxonMobil Corporation (Irvine, Texas).

ASPUN™ 6835A, an ethylene/alpha-olefin interpolymer composition having a density of 0.950 g/cc and a melt index (12) of 17 g/10 min, is commercially available from The Dow Chemical Company (Midland, Michigan).

ASPUN™ 6850A, an ethylene/alpha-olefin interpolymer composition having a density of 0.955 g/cc and a melt index (12) of 30 g/10 min, is commercially available from The Dow Chemical Company (Midland, Michigan).

VERSIFY™ 4301, a propylene-ethylene interpolymer having a density of 0.868 g/cc and melt flow rate of 25 g/10 min, is commercially available from The Dow Chemical Company (Midland, Michigan).

VERSIFY™ 4200, a propylene-ethylene interpolymer having a density of 0.876 g/cc and melt flow rate of 25 g/10 min, is commercially available from The Dow Chemical Company (Midland, Michigan).

VERSIFY™ 3200, a propylene-ethylene interpolymer having a density of 0.876 g/cc and melt flow rate of 8 g/10 min, is commercially available from The Dow Chemical Company (Midland, Michigan).

VERSIFY™ 3401, a propylene-ethylene interpolymer having a density of 0.865 g/cc and melt flow rate of 8 g/10 min, is commercially available from The Dow Chemical Company (Midland, Michigan).

DOW™ 10462N, a high density polyethylene homopolymer having a density of 0.963 g/cc and melt index (12) of 10 g/10 min, is commercially available from The Dow Chemical Company (Midland, Michigan).

DOWLEX™ 2517, an ethylene/alpha-olefin interpolymer composition having a density of 0.917 g/cc and melt index of 25 g/10 min, is commercially available from The Dow Chemical Company (Midland, Michigan).

DOWLEX™ 2027G, a linear low density polyethylene having a density of 0.941 g/cc and melt index of 4 g/10 min, is commercially available from The Dow Chemical Company (Midland, Michigan).

### Formation of Fibers

Fibers are spun on a Hills Bicomponent Continuous Filament Fiber Spinning Line. Bicomponent fibers having an eccentric core sheath configuration are made. The fibers are spun on the Hills Line according to the following conditions. Extruder profiles are adjusted to achieve a melt temperature of 230° C. Throughput rate of each hole is 0.6 ghm (grams per hole per minute). A Hills Bicomponent die is used and operated at a 40/60 core/sheath ratio (in weight) with the first region comprising a polymer in one extruder and second region comprising another polymer in the other extruder, in accordance with Table 4 below, to form Comparative Examples (CE) 1, 2, 3, 4, 5 and 6. The Hills Bicomponent die is operated at a 70/30 core/sheath ratio (in weight) with the first region comprising a polymer in one extruder and second region comprising another polymer in the other extruder, in accordance with Table 5 below, to form Comparative Examples (CE) 7, 8, 9, 10, 11, and 12 and Inventive Examples (IE) 1, 2, 3, 4, and 5. The die consists of 144 holes, with a hole diameter of 0.6 mm and a length/diameter (L/D) of 4/1. Quench air temperature and flow rate are set at 15-18° C., and 520 cfm (cubic feet per minute), respectively. After the quenching zone, a draw tension is applied on the 144 filaments by pneumatically entraining the filaments in a slot unit with an air stream. Velocity of the air stream is controlled by the slot aspirator pressure. For each example, four runs are conducted at different pressure, where the slot aspirator pressure is set at 20 psi for one run, 30 psi for another, 40 psi for another, and 50 psi for another. The curvature of the example fibers is measured for each run. Table 6 below provides the curvature data of the Inventive and Comparative Examples. As can be seen from the tables, the Inventive Examples, which have a weight ratio of the first region to the second region of 70:30 and comprise a polypropylene blend in the first region and an ethylene/alpha-olefin interpolymer composition in the second region, can exhibit enhanced curvature in comparison to the Comparative Examples. For example, Inventive Example 3 exhibits a curvature of 3.4 mm-1 at 30 psi, which is a curvature significantly higher than any of the Comparative Examples. Without being bound by any theory, it is the specific composition of the fiber, including the weight ratio and components of the regions (e.g., a polypropylene blend comprising a polypropylene homopolymer and propylene-ethylene interpolymer, where the propylene-ethylene interpolymer has a specific density and melt flow rate, and an ethylene/alpha-olefin interpolymer composition with a specific density and melt index (12), that gives rise to the capability of fibers with increased curvature.

TABLE 4
Fiber Comparative Examples 1-6 (40:60 Ratio). First centroid
is offset from the fiber centroid (Pᵣ₁/r) by 0.37; and second centroid
is offset from the fiber centroid (Pᵣ₂/r) by 0.25.

| | | | Weight Ratio - |
|---|---|---|---|
| | First Region | Second Region | First Region to |
| Ex. | (Core) | (Sheath) | Second Region |
| CE1 | Exxon PP 3155 | ASPUN ™ 6835A | 40:60 |
| CE2 | 70% Exxon PP 3155 + | ASPUN ™ 6835A | 40:60 |
| | 30% VERSIFY ™ 4301 | | |
| CE3 | Exxon PP 3155 | Resin 1 | 40:60 |
| CE4 | 70% Exxon PP 3155 + | Resin 1 | 40:60 |
| | 30% VERSIFY ™ 4301 | | |
| CE5 | Exxon PP 3155 | 80% Resin 1 + 20% | 40:60 |
| | | DOW ™ 10462N | |
| | | (I2 of this blend = | |
| | | 18 g/10 min) | |
| CE6 | 70% Exxon PP 3155 + | 80% Resin 1 + 20% | 40:60 |
| | 30% VERSITY ™ 4301 | DOW ™ 10462N | |
| | | (I2 of this blend = | |
| | | 18 g/10 min) | |

TABLE 5
Fiber Inventive Examples 1-5 and Comparative Examples
7-12 (70:30 Ratio). First centroid is offset from the fiber
centroid (Pᵣ₁/r) by 0.16; and second centroid is offset from
the fiber centroid (Pᵣ₂/r) by 0.38.

| | | | Weight Ratio - |
|---|---|---|---|
| | First Region | Second Region | First Region to |
| Ex. | (Core) | (Sheath) | Second Region |
| CE7 | Exxon PP 3155 | ASPUN ™ 6835A | 70:30 |
| CE8 | Exxon PP 3155 | Resin 2 | 70:30 |
| CE9 | 70% Exxon PP 3155 + | DOWLEX ™ 2517 | 70:30 |
| | 30% VERSITY ™ 4301 | | |
| CE10 | 70% Exxon PP 3155 + | ASPUN ™ 6835A | 70:30 |
| | 30% VERSITY ™ 3200 | | |
| CE11 | 70% Exxon PP 3155 + | ASPUN ™ 6835A | 70:30 |
| | 30% VERSITY ™ 3401 | | |
| CE12 | 70% Exxon PP 3155 + | ASPUN ™ 6850A | 70:30 |
| | 30% VERSITY ™ 4301 | | |
| IE1 | 70% Exxon PP 3155 + | ASPUN ™ 6835A | 70:30 |
| | 30% VERSITY ™ 4301 | | |
| IE2 | 70% Exxon PP 3155 + | Resin 2 | 70:30 |
| | 30% VERSITY ™ 4301 | | |
| IE3 | 70% Exxon PP 3155 + | Resin 1 | 70:30 |
| | 30% VERSITY ™ 4301 | | |
| IE4 | 70% Exxon PP 3155 + | 90% ASPUN ™ | 70:30 |
| | 30% VERSITY ™ 4301 | 6850A + 10% | |
| | | DOWLEX ™ 2027G | |
| | | (I2 of this blend = | |
| | | 23 g/10 min) | |
| IE5 | 70% Exxon PP 3155 + | ASPUN ™ 6835A | 70:30 |
| | 30% VERSITY ™ 4200 | | |

TABLE 6
Curvature Data

Curvature (1/mm)

| | 20 psi | 30 psi | 40 psi | 50 psi |
|---|---|---|---|---|
| CE1 | 0.7 | 1.2 | 0.6 | — |
| CE2 | 0.3 | 0.8 | 1.1 | 1.0 |
| CE3 | 0.5 | 1.4 | 0.9 | — |
| CE4 | 0.3 | 1.5 | 1.5 | 0.6 |
| CE5 | 0.6 | 1.0 | 1.1 | — |
| CE6 | 0.2 | 1.1 | 1.5 | 1.2 |
| CE7 | 1.2 | 1.3 | 0.7 | — |
| CE8 | 1.7 | <0.2 | <0.2 | — |
| CE9 | <0.2 | 1.1 | <0.2 | <0.2 |
| CE10 | 0.4 | 0.7 | 0.9 | 0.4 |
| CE11 | 0.6 | 1.0 | 0.7 | 0.4 |
| CE12 | 0.6 | 1.1 | 1.3 | 1.5 |
| IE1 | 1.5 | 1.8 | 1.9 | 0.9 |
| IE2 | 1.5 | 3.4 | 0.5 | <0.2 |
| IE3 | 1.3 | 2.1 | 4.1 | 0.6 |
| IE4 | 0.7 | 1.4 | 2.1 | 0.9 |
| IE5 | 0.7 | 0.9 | 1.9 | 1.2 |

Every document cited herein, if any, including any cross-referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention

1. A bicomponent fiber comprising:
a fiber centroid;
a first region having a first centroid and a second region having a second centroid;
the first region comprising a polypropylene blend comprising from 50 to 90 wt. % of a polypropylene homopolymer, based on the total weight of the polypropylene blend, and from 10 to 50 wt. % of a propylene-ethylene interpolymer, based on the total weight of the polypropylene blend, wherein the propylene-ethylene interpolymer has a density of from 0.860 to 0.880 g/cc and a melt flow rate of greater than 12 g/10 min;
the second region comprising an ethylene/alpha-olefin interpolymer composition having a density of greater than 0.920 g/cc and a melt index (12) of from 10 to 25 g/10 min;
wherein at least one of the first centroid and the second centroid is not the same as the fiber centroid; and
wherein the weight ratio of the first region to the second region is from 55:45 to 90:10.

2. The bicomponent fiber of claim 1, wherein the ethylene/alpha-olefin interpolymer composition has:
a density in the range of 0.930 to 0.965 g/cc;
a molecular weight distribution, expressed as the ratio of the weight average molecular weight to number average molecular weight (M_{w(GPC)}/M_{n(GPC)}) as determined by GPC in the range of from 1.5 to 2.6;
a tan delta at 1 radian/second of at least 45;
a low temperature peak and a high temperature peak on an improved comonomer composition distribution (ICCD) elution profile by Crystallization Elution Fractionation between 35° C. to 110° C., and
a full width at half maximum of the high temperature peak is less than 6.0° C.

3. The bicomponent fiber of claim 1, wherein the first centroid or the second centroid is offset from the fiber centroid by at least 0.1.

4. The bicomponent fiber of claim 1, wherein the first and second regions are arranged in core sheath, side by side, segmented pie, or islands-in-the-sea structures.

5. The bicomponent fiber of claim 1, wherein the bicomponent fiber has a curvature of at least 1.6 mm⁻¹.

6. The bicomponent fiber of claim 1, wherein the bicomponent fiber further comprises a third region comprising a polymer different from those in the first and second regions.

7. A nonwoven fabric comprising the bicomponent fiber of claim 1.
